(19) United States
(12) Patent Application Publication
(10) Pub. No.: US 2012/0080644 A1
(43) Pub. Date: Apr. 5, 2012

(54) PROCESS, ABSORPTION MEDIUM, AND APPARATUS FOR ABSORPTION OF CO2 FROM GAS MIXTURES

(75) Inventors: Matthias Seiler, Griesheim (DE); Jörn Rolker, Alzenau (DE); Rolf Schneider, Grundau-Rathenbergen (DE); Axel Kobus, Langen (DE); Daniel Witthaut, Wehrheim (DE); Manfred Neumann, Marl (DE); Michael Keup, Marl (DE); Daniel Dembkowski, Essen (DE); Wolfgang Benesch, Bochum (DE); Hermann Winkler, Recklinghausen (DE); Jens Reich, Muhlheim an der Ruhr (DE); Thomas Riethmann, Essen (DE)

(73) Assignee: Evonik Degussa GmbH, Essen (DE)

(21) Appl. No.: 13/375,822

(22) PCT Filed: May 28, 2010
(86) PCT No.: PCT/EP2010/057389

§ 371 Date: Dec. 2, 2011

(30) Foreign Application Priority Data
Jun. 5, 2009 (EP) 09162003.9

(51) Int. Cl. B01D 53/62; B01J 10/00; C09K 3/00; B01D 53/14; B01D 53/96

(52) U.S. Cl. 252/190; 423/228; 422/612

(57) ABSTRACT

CO₂ is absorbed from a gas mixture by contacting the gas mixture with an absorption medium which comprises water and 2,3-dihydro-2,2,4,6-tetramethylpyridine. The absorption media of the invention include water, 2,3-dihydro-2,2,4,6-tetramethylpyridine, and at least one organic solvent in a homogeneous phase. An apparatus of the invention for removing CO₂ from a gas mixture comprises an absorption unit, a desorption unit, and a circulating absorption medium of the invention.

### TECHNICAL FIELD

The invention relates to a process for the absorption of CO₂ from a gas mixture, and also an absorption medium and an apparatus for carrying out the process.

The absorption of CO₂ from a gas mixture is of particular interest for removing carbon dioxide from flue gases, especially for reducing the emission of carbon dioxide, which is considered to be a main cause of the greenhouse effect, from power station processes. Absorption of CO₂ is likewise of interest for removing CO₂ from natural gas, biogas, synthesis gas or CO₂-containing gas streams in refineries. In addition, carbon dioxide is required for some processes and CO₂ can be made available as starting material for these processes by the process of the invention.

### PRIOR ART

On an industrial scale, aqueous solutions of alkanolamines are typically used as absorption medium for absorbing CO₂ from a gas mixture. The loaded absorption medium is regenerated by heating, depressurization to a lower pressure or stripping, resulting in the carbon dioxide being desorbed. After the regeneration process, the absorption medium can be reused. These processes are described, for example, in Rolker, J.; Arlt, W.; “Abtrennung von Kohlendioxid aus Rauchgasen mittels Absorption” in Chemie Ingenieur Technik 2006, 78, pages 416 to 424.

These processes have the disadvantage that a relatively large quantity of energy is required for separating off CO₂ by absorption and subsequent desorption and that only part of the absorbed CO₂ is desorbed again during desorption, so that the proportion of the alkanolamine utilized for absorption of CO₂ in a cycle of absorption and desorption is low. In addition, the absorption media used are strongly corrosive.

The use of ionic liquids for the absorption of CO₂ is described in X. Zhang et al., “Screening of ionic Liquids to Capture CO₂ by COSMO-RS and Experiments”, AIChE Journal, Vol. 54, pages 2171 to 2728.

### DESCRIPTION OF THE INVENTION

It has surprisingly been found that the disadvantages of the known processes can be avoided by the use of 2,3-dihydro-2,2,4,6-tetramethylpyridine for the absorption of CO₂ from a gas mixture.

The invention therefore provides a process for the absorption of CO₂ from a gas mixture by bringing the gas mixture into contact with an absorption medium comprising water and 2,3-dihydro-2,2,4,6-tetramethylpyridine.

The invention also provides an absorption medium comprising water, 2,3-dihydro-2,2,4,6-tetramethylpyridine and at least one organic solvent in a homogeneous phase.

The invention additionally provides an apparatus for the separation of CO₂ from a gas mixture, which comprises an absorption unit, a desorption unit and a circulating absorption medium comprising water, 2,3-dihydro-2,2,4,6-tetramethylpyridine and at least one organic solvent in a homogeneous phase.

In the process of the invention, the absorption of CO₂ is effected by bringing a gas mixture into contact with an absorption medium comprising water and 2,3-dihydro-2,2,4,6-tetramethylpyridine. 2,3-Dihydro-2,2,4,6-tetramethylpyridine can be prepared from acetone and ammonia by the processes described in U.S. Pat. No. 2,516,625 and U.S. Pat. No. 4,701,530.

Apart from 2,3-dihydro-2,2,4,6-tetramethylpyridine, the absorption medium can also contain one or more tautomers of 2,3-dihydro-2,2,4,6-tetramethylpyridine, in particular 2,5-dihydro-2,2,4,6-tetramethylpyridine, 1,2-dihydro-2,2,4,6-tetramethylpyridine and 1,2,3,4-tetrahydro-2,2,6-trimethyl-4-methylenepyridine.

In the process of the invention, the absorption medium preferably further comprises at least one water-miscible organic solvent in addition to water and 2,3-dihydro-2,2,4,6-tetramethylpyridine. For the purposes of the invention, the term “a water-miscible organic solvent” refers to a solvent which dissolves to an extent of at least 10% by weight in water, or at least 10% by weight of water dissolves in the solvent. Particular preference is given to water-miscible organic solvents which have no miscibility gap with water and are miscible with water in any ratio.

In a preferred embodiment, the absorption medium comprising water, 2,3-dihydro-2,2,4,6-tetramethylpyridine and at least one water-miscible organic solvent is present as a single phase. The single-phase nature of the absorption medium can be achieved by appropriate choice of the water-miscible organic solvents and appropriate choice of the proportions of water, 2,3-dihydro-2,2,4,6-tetramethylpyridine and water-miscible organic solvents.

Preference is likewise given to embodiments which use an absorption medium comprising water, 2,3-dihydro-2,2,4,6-tetramethylpyridine and at least one water-miscible organic solvent, in which the absorption medium is present as a single phase after absorption of CO₂. The single-phase nature of the absorption medium after the absorption of CO₂ can be influenced by the same factors as the single-phase nature of the absorption medium prior to absorption and can be additionally influenced by the choice of the temperature and the pressure during the contacting of the gas mixture with the absorption medium.

The process of the invention can in principle be carried out using any gas mixture which contains CO₂, in particular combustion flue gases; off-gases from biological processes such as composting, fermentation or water treatment plants; off-gases from calcination processes such as calcination of limestone or cement production; residual gases from blast furnace processes for iron production; residual gases from chemical processes, e.g. off-gases from carbon black production or the preparation of hydrogen by steam reforming; CO₂-containing natural gas and biogas; synthesis gas; and CO₂-containing gas streams in refinery processes.

The gas mixture is preferably a combustion flue gas, particularly preferably a combustion flue gas containing from 1 to 60% by volume of CO₂, in particular from 2 to 20% by volume of CO₂. In a particularly preferred embodiment, the gas mixture is a combustion flue gas from a power station process, in particular a desulphurized combustion flue gas from a power station process. In the particularly preferred embodiment involving a desulphurized combustion flue gas from a power station process, all desulphurization methods known for power station processes can be used, preferably gas scrubbing with milk of lime, with aqueous ammonia by the Walther process or by the Wellmann-Lord process. In the process of the invention, CO₂ is preferably absorbed from a gas mixture containing less than 10% by volume of O₂, particularly preferably less than 6% by volume of O₂.

In a further preferred embodiment, the gas mixture is a natural gas or a biogas containing methane as main constituent in addition to CO₂, with the total amount of CO₂ and methane preferably being more than 50% by volume and in particular more than 80% by volume.

In the process of the invention, all apparatuses suitable for bringing a gas phase into contact with a liquid phase can be used to bring the gas mixture into contact with the absorption medium. Preference is given to using gas scrubbers or absorption columns known from the prior art, for example membrane contactors, radial flow scrubbers, jet scrubbers, Venturi scrubbers, rotating spray scrubbers, packed-bed columns, packing columns and tray columns. Particular preference is given to using absorption columns operated in countercurrent.

In the process of the invention, the absorption of CO₂ is preferably carried out at a temperature of the absorption medium in the range from 0 to 70° C., particularly preferably from 20 to 60° C. When using an absorption column operated in countercurrent, the temperature of the absorption medium is particularly preferably from 30 to 60° C. on entering the column and from 35 to 70° C. on leaving the column.

The absorption of CO₂ is preferably carried out at a pressure of the gas mixture in the range from 0.8 to 50 bar, particularly preferably from 0.9 to 30 bar. In a particularly preferred embodiment, the absorption is carried out at a total pressure of the gas mixture in the range from 0.8 to 1.5 bar, in particular from 0.9 to 1.1 bar. This particularly preferred embodiment makes it possible to absorb CO₂ from the combustion flue gas of a power station without compression of the combustion flue gas.

In a preferred embodiment of the process of the invention, CO₂ absorbed in the absorption medium is desorbed again by increasing the temperature and/or reducing the pressure and after this desorption of CO₂ the absorption medium is reused for the absorption of CO₂. CO₂ can be partly or completely separated from the gas mixture and be obtained separately from other components of the gas mixture with such a cyclic process of absorption and desorption.

As an alternative to increasing the temperature or reducing the pressure or in addition to a temperature increase and/or a pressure reduction, desorption can also be carried out by stripping the CO₂-laden absorption medium with a gas.

When water is also removed from the absorption medium during desorption in addition to CO₂, water can be added to the absorption medium before it is reused for absorption, if necessary.

The desorption can be carried out using all apparatuses which are known from the prior art for the desorption of a gas from a liquid. The desorption is preferably carried out in a desorption column. As an alternative, the desorption of CO₂ can also be carried out in one or more flash evaporation stages.

In a desorption effected by increasing the temperature, the desorption of CO₂ is preferably carried out at a temperature of the absorption medium in the range from 50 to 200° C., particularly preferably from 80 to 150° C. The temperature in the desorption is preferably at least 20° C. above, particularly preferably at least 50° C. above, the temperature in absorption.

In a desorption effected by reducing the pressure, the desorption of CO₂ is preferably carried out at a total pressure in the gas phase in the range from 0.01 to 10 bar, in particular from 0.1 to 5 bar. The pressure in the desorption is in this case preferably at last 1.5 bar below, particularly preferably at least 4 bar below, the pressure in the absorption.

In a desorption effected by increasing the temperature, the pressure in the desorption of CO₂ can also be higher than in the absorption of CO₂. In this embodiment, the pressure in the desorption of CO₂ is preferably up to 5 bar above, particularly preferably up to 3 bar above, the pressure in the absorption of CO₂. This embodiment enables the CO₂ separated off from the gas mixture to be compressed to a higher pressure than that of the gas mixture without use of mechanical energy. The single-phase nature of the absorption medium can be ensured by means of a higher pressure in the desorption.

The absorption medium of the invention comprises water, 2,3-dihydro-2,2,4,6-tetramethylpyridine and at least one organic solvent in a homogeneous phase. Preference is given to using organic solvents which have a boiling point of more than 100° C. at 1 bar, particularly preferably more than 150° C. at 1 bar. The absorption medium of the invention preferably additionally comprises CO₂.

The absorption medium of the invention contains water and organic solvent in a weight ratio which is preferably from 10:1 to 1:1, particularly preferably in the range from 5:1 to 2:1. The weight ratio of organic solvent to 2,3-dihydro-2,2,4,6-tetramethylpyridine is preferably in the range from 3:1 to 1:3, particularly preferably in the range from 2:1 to 1:2. Particular preference is given to absorption media comprising from 10 to 80% by weight of water, from 5 to 50% by weight of 2,3-dihydro-2,2,4,6-tetramethylpyridine and from 5 to 50% by weight of organic solvent.

In a preferred embodiment, the absorption medium of the invention contains sulfolane, CAS No. 126-33-0, as organic solvent, preferably in a proportion of sulfolane of at least 5% by weight, particularly preferably at least 10% by weight and in particular at least 25% by weight.

In a further preferred embodiment, the absorption medium of the invention contains at least one ionic liquid as organic solvent, preferably in a proportion of ionic liquid of at least 5% by weight, particularly preferably at least 10% by weight and in particular at least 25% by weight.

For the purposes of the invention, an ionic liquid is a salt composed of anions and cations or a mixture of such salts, where the salt or the mixture of salts has a melting point of less than 100° C. The ionic liquid preferably comprises one or more salts of organic cations with organic or inorganic anions. Mixtures of a plurality of salts having different organic cations and the same anion are particularly preferred.

Particularly suitable organic cations are cations of the general formulae (I) to (V):

R¹R²R³R⁴N⁺ (I)

R¹R²R³R⁴P⁺ (I)

R¹R²R³S⁺ (III)

R¹R²N⁺═C(NR³R⁴)(NR⁵R⁶) (IV)

R¹R²N⁺═C(NR³R⁴)(XR⁵) (V)

where
R¹, R², R³, R⁴, R⁵, R⁶ are identical or different and are each hydrogen, a linear or branched aliphatic or olefinic hydrocarbon radical having from 1 to 30 carbon atoms, a cycloaliphatic or cycloolefinic hydrocarbon radical having from 5 to 40 carbon atoms, an aromatic hydrocarbon radical having from 6 to 40 carbon atoms, an alkylaryl radical having from 7 to 40 carbon atoms, a linear or branched aliphatic or olefinic hydrocarbon radical which has from 2 to 30 carbon atoms and is interrupted by one or more —O—, —NH—, —NR′—, —O—C(O)—, —(O)C—O—, —NH—C(O)—, —(O)C≡NH—, —(CH₃)N—C(O)—, —(O)C≡N(CH₃)—, —S(O₂)—O—, —O—S(O₂)—, —S(O₂)—NH—, —NH—S(O₂)—, —S(O₂)—N(CH₃)— or —N(CH₃)—S(O₂)— groups, a linear or branched aliphatic or olefinic hydrocarbon radical which has from 1 to 30 carbon atoms and is terminally functionalized by OH, OR′, NH₂, N(H)R′ or N(R′)₂ or a polyether radical of the formula —(R⁷—O)ₙ—R⁸ which has a block or random structure, where R⁵ is not hydrogen in the case of cations of the formula (V),
R′ is an aliphatic or olefinic hydrocarbon radical having from 1 to 30 carbon atoms,
R⁷ is a linear or branched alkylene radical containing from 2 to 4 carbon atoms,
n is from 1 to 200, preferably from 2 to 60,
R⁸ is hydrogen, a linear or branched aliphatic or olefinic hydrocarbon radical having from 1 to 30 carbon atoms, a cycloaliphatic or cycloolefinic hydrocarbon radical having from 5 to 40 carbon atoms, an aromatic hydrocarbon radical having from 6 to 40 carbon atoms, an alkylaryl radical having from 7 to 40 carbon atoms or a —C(O)—R⁹ radical,
R⁹ is a linear or branched aliphatic or olefinic hydrocarbon radical having from 1 to 30 carbon atoms, a cycloaliphatic or cycloolefinic hydrocarbon radical having from 5 to 40 carbon atoms, an aromatic hydrocarbon radical having from 6 to 40 carbon atoms or an alkylaryl radical having from 7 to 40 carbon atoms,
X is an oxygen atom or a sulphur atom,

where at least one and preferably all of the radicals R¹, R², R³, R⁴, R⁵ and R⁶ is different from hydrogen.

Cations of the formulae (I) to (V) in which the radicals R¹ and R³ together form a 4- to 10-membered, preferably 5- to 6-membered, ring are likewise suitable.

In the cations of the formula (IV), the radicals R¹ to R⁵ are preferably methyl groups and the radical R⁶ is preferably an ethyl group or n-propyl group.

In the cations of the formula (V), the radicals R¹ to R⁴ are preferably methyl groups.

Heteroaromatic cations having at least one quaternary nitrogen atom in the ring, the nitrogen atom bearing a radical R¹ as defined above, are likewise suitable, preferably derivatives of pyrrole, pyrazole, imidazole, oxazole, isoxazole, thiazole, isothiazole, pyridine, pyrimidine, pyrazine, indole, quinoline, isoquinoline, cinnoline, quinoxaline or phthalazine which are substituted on the nitrogen atom.

Suitable inorganic anions are, in particular, tetrafluoroborate, hexafluorophosphate, nitrate, sulphate, hydrogensulphate, phosphate, hydrogenphosphate, dihydrogenphosphate, hydroxide, carbonate, hydrogencarbonate and the halides, preferably chloride.

Suitable organic anions are, in particular, R^{a}OSO₃⁻, R^{a}SO₃⁻, R^{a}OPO₃²⁻, (R^{a}O)₂PO₂⁻, R^{a}PO₃²⁻, R^{a}COO⁻, R^{a}O⁻, (R^{a}CO)₂N⁻, (R^{a}SO₂)₂N⁻, NCN⁻, R^{b}₃ PF₃— and R^{b}BF₃—, where R^{a} is a linear or branched aliphatic hydrocarbon radical having from 1 to 30 carbon atoms, a cycloaliphatic hydrocarbon radical having from 5 to 40 carbon atoms, an aromatic hydrocarbon radical having from 6 to 40 carbon atoms, an alkylaryl radical having from 7 to 40 carbon atoms or a linear or branched perfluoroalkyl radical having 1 to 30 carbon atoms and R^{b} is a perfluoroalkyl radical having from 1 to 30 carbon atoms, preferably from 1 to 3 carbon atoms.

In a preferred embodiment, the ionic liquid comprises one or more 1,3-dialkylimidazolium salts, where the alkyl groups are particularly preferably selected independently of each other from methyl, ethyl, n-propyl, n-butyl and n-hexyl.

In a further preferred embodiment, the ionic liquid comprises one or more quaternary ammonium salts having a monovalent anion and cations of the general formula (I) in which

R¹ is an alkyl radical having from 1 to 20 carbon atoms,
R² is an alkyl radical having from 1 to 4 carbon atoms,
R³ is a (CH₂CHRO)ₙ—H radical where n is from 1 to 200 and

### R═H or CH₃ and

R⁴ is an alkyl radical having from 1 to 4 carbon atoms or a (CH₂CHRO)ₙ—H radical where n is from 1 to 200 and R═H or CH₃.

Processes for preparing the ionic liquids are known to those skilled in the art from the prior art.

In the process according to the invention, preferably the above-described absorption media according to the invention are used.

In the process of the invention, the absorption medium can contain additives, preferably corrosion inhibitors and/or additives which promote wetting, in addition to the abovementioned components.

As corrosion inhibitors, it is possible to use all substances known to those skilled in the art as suitable corrosion inhibitors for processes for the absorption of CO₂ using alkanolamines, in particular the corrosion inhibitors described in U.S. Pat. No. 4,714,597.

As additive which promotes wetting, preference is given to using one or more surfactants from the group consisting of nonionic surfactants, zwitterionic surfactants and cationic surfactants.

Suitable nonionic surfactants are alkylamine alkoxylates, amidoamines, alkanolamides, alkylphosphine oxides, alkyl N-glucamides, alkyl glucosides, bile acids, alkyl alkoxylates, sorbitan esters, sorbitan ester ethoxylates, fatty alcohols, fatty acid ethoxylates, ester ethoxylates and polyether siloxanes.

Suitable zwitterionic surfactants are betaines, alkylglycines, sultaines, amphopropionates, amphoacetates, tertiary amine oxides and silicobetaines.

Suitable cationic surfactants are quaternary ammonium salts having one or two substituents having from 8 to 20 carbon atoms, in particular corresponding tetraalkylammonium salts, alkylpyridinium salts, ester quats, diamidoamine quats, imidazolinium quats, alkoxyalkyl quats, benzyl quats and silicone quats.

In a preferred embodiment, the additive which promotes wetting comprises one or more nonionic surfactants of the general formula R(OCH₂CHR′)ₘOH where m is from 4 to 40, R is an alkyl radical having from 8 to 20 carbon atoms, an alkylaryl radical having from 8 to 20 carbon atoms or a polypropylene oxide radical having from 3 to 40 propylene oxide units and R′ is methyl or preferably hydrogen.

In a further preferred embodiment, the additive which promotes wetting comprises a polyether-polysiloxane copolymer containing more than 10% by weight of [Si(CH₃)₂O] units and more than 10% by weight of [CH₂CHR—O] units, where R is hydrogen or methyl. Particular preference is given to polyether-polysiloxane copolymers of the general formulae ((VI) to (VIII):

(CH₃)₃Si—O—[SiR¹(CH₃)—O]ₙ—Si(CH₃)₃ (VI)

R²O-Aₚ-[B-A]ₘ-A_{q}-R² (VII)

R²O-[A-Z]ₚ—[B—Si(CH₃)₂—Z—O-A-Z]ₘ—B—Si(CH₃)₂[Z—O-A]_{q}O_{1-q}R² (VIII)

where

A is a divalent radical of the formula —[CH₂CHR³—O]ᵣ—,
B is a divalent radical of the formula —[Si(CH₃)₂—O]ₛ—,
Z is a divalent linear or branched alkylene radical having from 2 to 20 carbon atoms and preferably —(CH₂)₃—,
n=1 to 30,
m=2 to 100,
p, q=0 or 1,
r=2 to 100,
s=2 to 100,
from 1 to 5 of the radicals R¹ are radicals of the general formula —Z—O-A-R² and the remaining radicals R¹ are each methyl,
R² is hydrogen or an aliphatic or olefinic alkyl radical or acyl radical having from 1 to 20 carbon atoms and
R³ is hydrogen or methyl.

The additives which promote wetting are known to those skilled in the art from the prior art as additives for aqueous solutions and can be prepared by methods known from the prior art.

An apparatus according to the invention for the separation of CO₂ from a gas mixture comprises an absorption unit, a desorption unit and a circulating absorption medium according to the invention. The apparatuses described above for absorption in a process according to the invention are suitable as absorption unit of the apparatus of the invention. Apparatuses described above for desorption in a process according to the invention are suitable as desorption unit of the apparatus of the invention. The apparatus of the invention preferably comprises an absorption unit and a desorption unit as are known to those skilled in the art from apparatuses for the separation of CO₂ from a gas mixture with the use of an alkanolamine.

Due to the use of 2,3-dihydro-2,2,4,6-tetramethylpyridine in the absorption medium, the process of the invention and the absorption media of the invention allow for a higher degree of loading of the absorption medium with CO₂ in the absorption at low temperatures, compared to the known processes and absorption media, in particular compared to the alkanolamines which are usually used in industry, where the degree of loading refers, for the purposes of the invention, to the molar ratio of CO₂ to amine in the absorption medium. In addition, the absorption medium of the process of the invention is less corrosive and shows a higher chemisorption rate for CO₂ than absorption media containing alkanolamines. In the embodiment of a cyclic process comprising absorption and desorption, an improved carbon dioxide differential is also achieved compared to the known processes and absorption media, in particular compared to alkanolamines, where, for the purposes of the invention, the carbon dioxide differential is the difference between the degree of loading of the absorption medium with CO₂ after absorption of CO₂ and the degree of loading of the absorption medium with CO₂ after desorption of CO₂. These advantages allow more effective absorption of CO₂ from gas mixtures having a low CO₂ partial pressure and also make it possible to reduce the size of the apparatuses and reduce the energy consumption compared to the processes known from the prior art. Owing to the lower corrosiveness, a smaller amount of corrosion inhibitors is required in the process of the invention than in the known processes.

Absorption media according to the invention which contain at least one ionic liquid in addition to water and 2,3-dihydro-2,2,4,6-tetramethylpyridine allow the desorption of CO₂ to be carried out at higher temperatures and/or lower pressures without a loss of solvent occurring during desorption or a precipitation of solid or a phase separation of the absorption medium occurring as a result of the evaporation of water.

The following examples illustrate the invention but do not restrict the scope of the invention.

### EXAMPLES

### Example 1

A mixture of 15% by weight of 2,3-dihydro-2,2,4,6-tetramethylpyridine, 15% by weight of sulpholane and 70% by weight of water was placed at constant temperature in a thermostated apparatus for measuring gas-liquid equilibria provided with a pressure regulator and brought into contact with gaseous carbon dioxide at constant pressure, with pressure and temperature being varied. After the equilibrium state had been reached in each case, the content of absorbed CO₂ in the loaded absorption medium was determined and the degree of loading was calculated therefrom as molar ratio of CO₂ to amine in the loaded absorption medium. The temperatures and pressures studied and the degrees of loading determined for these are summarized in Table 1. At the pressures and temperatures studied, the absorption medium was composed of a single phase and homogeneous before and after the absorption of CO₂.

### Example 2

### Comparative Example

Example 1 was repeated using a mixture of 30% by weight of monoethanolamine (MEA) and 70% by weight of water.

From the degrees of loading result the carbon dioxide differentials listed in Table 2 for absorption and desorption at 1.5 bar and desorption by increasing the temperature from 40 to 120° C. and also the carbon dioxide differentials indicated in Table 3 for absorption and desorption at 120° C. and desorption by reducing the pressure from 1.5 to 0.5 bar.

TABLE 1

| | Pressure | Temperature | Degree of loading |
|---|---|---|---|
| Example | [bar] | [° C.] | [mol of CO₂/mol of amine] |
| 1 | 0.5 | 40 | 0.62 |
| 1 | 1.5 | 40 | 0.81 |
| 1 | 0.5 | 120 | 0.07 |
| 1 | 1.5 | 120 | 0.21 |
| 2* | 0.5 | 40 | 0.56 |
| 2* | 1.5 | 40 | 0.63 |
| 2* | 0.5 | 120 | 0.33 |
| 2* | 1.5 | 120 | 0.41 |

*not according to the invention

TABLE 2

| | Carbon dioxide differential |
|---|---|
| Example | [mol of CO₂/mol of amine] |
| 1 | 0.60 |
| 2* | 0.22 |

*not according to the invention

TABLE 3

| | Carbon dioxide differential |
|---|---|
| Example | [mol of CO₂/mol of amine] |
| 1 | 0.14 |
| 2* | 0.08 |

*not according to the invention

1-18. (canceled)

19. A process for the absorption of CO₂ from a gas mixture, comprising contacting the gas mixture with an absorption medium comprising water and 2,3-dihydro-2,2,4,6-tetramethylpyridine.

20. The process of claim 19, wherein the absorption medium comprises at least one water-miscible organic solvent.

21. The process of claim 20, wherein the absorption medium is present as a single phase.

22. The process of claim 20, wherein the absorption medium is present as a single phase after the absorption of CO₂.

23. The process of claim 21, wherein the absorption medium is present as a single phase after the absorption of CO₂.

24. The process of claim 19, wherein the gas mixture is a combustion flue gas, a natural gas or a biogas.

25. The process of claim 19, wherein CO₂ absorbed in the absorption medium is desorbed in a desorption by increasing temperature, reducing pressure or a combination of both and the absorption medium after said desorption is reused for the absorption of CO₂.

26. The process of claim 25, wherein the absorption is carried out at a temperature in the range from 0 to 70° C. and the desorption is carried out at a higher temperature in the range from 50 to 200° C.

27. The process of claim 25, wherein the absorption is carried out at a pressure in the range from 0.8 to 50 bar and the desorption is carried out at a lower pressure in the range from 0.01 to 10 bar.

28. The process of claim 26, wherein the absorption is carried out at a pressure in the range from 0.8 to 50 bar and the desorption is carried out at a lower pressure in the range from 0.01 to 10 bar.

29. An absorption medium for the absorption of CO₂ from a gas mixture, comprising water, 2,3-dihydro-2,2,4,6-tetramethylpyridine and at least one organic solvent in a homogeneous phase.

30. The absorption medium of claim 29, further comprising CO₂.

31. The absorption medium of claim 29, having a weight ratio of water to organic solvent in the range from 10:1 to 1:1.

32. The absorption medium of claim 29, having a weight ratio of organic solvent to 2,3-dihydro-2,2,4,6-tetramethylpyridine in the range from 3:1 to 1:3.

33. The absorption medium of claim 29, comprising from 10 to 80% by weight of water, from 5 to 50% by weight of 2,3-dihydro-2,2,4,6-tetramethylpyridine and from 5 to 50% by weight of organic solvent.

34. The absorption medium of claim 29, comprising sulpholane as organic solvent.

35. The absorption medium of claim 29, comprising an ionic liquid as organic solvent.

36. The process of claim 19, wherein said absorption medium comprises water, 2,3-dihydro-2,2,4,6-tetramethylpyridine and at least one organic solvent in a homogeneous phase.

37. An apparatus for the separation of CO₂ from a gas mixture, comprising an absorption unit, a desorption unit and a circulating absorption medium, wherein said absorption medium comprises water, 2,3-dihydro-2,2,4,6-tetramethylpyridine and at least one organic solvent in a homogeneous phase.
